(19) United States
(12) Patent Application Publication
(10) Pub. No.: US 2022/0179234 A1
(43) Pub. Date: Jun. 9, 2022

(54) ADAPTER DEVICE FOR A LENS PANEL FOR OPTICALLY GLAZING WITH SPECTACLE LENSES

(71) Applicant: Christoph Rauter, Wien (AT)

(72) Inventor: Christoph Rauter, Wien (AT)

(21) Appl. No.: 17/437,696

(22) PCT Filed: Aug. 27, 2019
(86) PCT No.: PCT/AT2019/060274

§ 371 Date: Sep. 9, 2021

(30) Foreign Application Priority Data
Jun. 19, 2019 (AT) A60156/2019

(51) Int. Cl. G02C 1/06; G02C 7/16

(52) U.S. Cl. CPC G02C 1/06; G02C 7/16

(57) ABSTRACT

The invention relates to an adapter means (1) for the view panel (4) of a pair of goggles or a helmet visor, wherein the adapter means (1) comprises a bar-shaped edge element (5) with a first support surface (6) for supporting an outer panel (2) and a second support surface (7) for supporting an inner panel (3), wherein the support surfaces (6, 7) are not parallel to one another. The invention further relates to a view panel (4), a pair of goggles and a helmet.

The present invention relates to an adapter means for the view panel of a pair of goggles or a helmet visor according to the preamble of the independent patent claim. The invention further relates to a view panel comprising said adapter means, to a pair of goggles or a helmet visor having a view panel according to the invention, and to a helmet having such a helmet visor.

The use of conventional optical vision aids, in particular goggles with optical lenses, in combination with safety goggles, sports goggles, helmet visors or the like is often uncomfortable for the user and can be associated with numerous problems that limit wearing comfort and safety of use. For example, optical vision aids can slip when worn, and their view panels can fog up due to condensed liquid. To prevent rapid scratching of the optical lenses, or to better protect the user's eye from external influences, a combination of multiple view panels would be desirable.

In the prior art, various means are known that allow the combined use of optical lenses of goggles with, for example, view panels of safety goggles. However, such means have various disadvantages.

One problem arises in particular when using view panels with a curvature profile that is not identical to that of the optical lenses. In this context, the term curvature profile refers to the progression of the curvature curves of a panel along two orthogonal directions.

For example, toric view panels are known, which are also referred to as cylindrical view panels. Such toric or cylindrical view panels have a different curvature in two mutually orthogonal spatial directions. Toric view panels are used in ski goggles or motocross goggles, for example.

The combination of toric view panels with optical lenses of goggles is problematic in that optical lenses are typically spherical. This means that in optical lenses the radii of the curvature curves of the curvature profile are identical in two mutually orthogonal directions. Now, if they are combined with toric view panels, the curvature profiles of the optical lens and the view panel are not parallel so that the image quality is degraded. If spherical optical lenses are connected directly to toric view panels, they do not touch each other evenly due to the different curvature profiles and rapid fogging occurs, which is undesirable for wearing comfort. Furthermore, a high mechanical stress occurs at the connection points between the optical lenses and the view panel, so that the connection can tear even after a short time.

Therefore, it is an object of the present invention to overcome the above-described problems of the prior art and to create a means which enables a combination or a connection of panels with different curvature profiles or with a different curvature geometry.

This and other objects of the invention are solved by an adapter means with the features of the independent patent claim.

The invention provides that the adapter means comprises at least one bar-shaped edge element with a first support surface for supporting an outer panel and a second support surface for supporting an inner panel, wherein the support surfaces are not parallel to one another.

In the context of the present invention, “parallel” means in particular that the normal distance of all points of two or more curves or planes is greater than or equal to zero.

The adapter means according to the invention allows the curvature profile of the inner panel to be decoupled from the curvature profile of the outer panel, wherein the two panels can still be firmly connected to one another. Thus, panels with any curvature profile can be connected to one another.

It is optionally provided that the first support surface has a first curvature profile, which is formed by two curvature curves, and that the second support surface has a second curvature profile, which is formed by two curvature curves, wherein the first curvature profile differs from the second curvature profile.

In this context, the curvature curves refer to those two curves that result as sectional curves when the support surfaces are intersected by two mutually orthogonal normal planes. The orientation of the normal planes is orthogonal relative to the respective support surface. In particular, the two normal planes may be a horizontal plane and a vertical plane. The two curvature curves define the curvature profile of a support surface. Each curvature curve may extend as a straight line, a circular arc, a parable, a hyperbola or any other curve shape, for example.

The curvature profile of a support surface may also be planar. This is the case when the respective curvature curves are straight lines.

The curvature profile of a support surface is referred to as toric or cylindrical if one curvature curve of the curvature profile has an arcuate shape and the other curvature curve is a straight line. However, the curvature profile of a support surface can also be referred to as toric if both curvature curves of the curvature profile have an arcuate shape with different radii of curvature.

However, the curvature profile of a support surface can be referred to as spherical if both curvature curves of the curvature profile have an arcuate shape and substantially the same radius of curvature. The curvature profile of a spherical support surface substantially corresponds to a spherical shell.

Thus, the different curvature profiles of the support surfaces of the adapter means allow compensating for the different geometries of the outer panel and the inner panel.

It may optionally be provided that the first curvature profile has no curvature, i.e. is flat. It may optionally be provided that the first curvature profile has a curvature in one spatial direction. It may optionally be provided that the first curvature profile has a curvature in two mutually orthogonal spatial directions.

It may also be provided that the second curvature profile has no curvature, i.e. is flat. It may optionally also be provided that the second curvature profile has a curvature in one spatial direction. It may optionally be provided that the second curvature profile has a curvature in two mutually orthogonal spatial directions.

In particular, it may be provided that at least one curvature curve, preferably both curvature curves, of the first support surface or the second support surface have a substantially arcuate shape so that the respective support surface is substantially spherical.

It may be provided that the first support surface has a curvature profile that is formed by two curvature curves whose radii of curvature are substantially different, and in that the second support surface has a curvature profile that is formed by two curvature curves whose radii of curvature are substantially the same. Thus, the first support surface may in particular have a toric geometry and the second support surface may have a spherical geometry.

Thus, a particularly preferable adaptation of optical lenses or optical glasses to toric or cylindrical view panels is enabled.

Optionally, it may be provided that a viewing clearance is provided in the edge element. Preferably, it may be one single viewing clearance. Thus, the edge element may in particular be designed as a circumferential bar. In particular, the edge element may be designed as a single piece.

Alternatively, the edge element may also be designed as multiple pieces. In particular, a first edge element for attaching a first outer and inner panel and a separate second edge element for attaching a second outer and inner panel may be provided. In particular, this may be the right and left side of a pair of sports goggles.

Preferably, the size of the edge element/viewing clearance of the edge element is suitable so that the field of vision of the user is not or only minimally restricted. Thus, the size of the viewing clearance may be adapted to the respective prevailing conditions.

Preferably, the edge element is designed in such a way that it does not obstruct the ventilation openings provided in typical goggles or visors.

In particular, the curvature profile of the support surfaces may be determined by the height, the curvature and the orientation of the support areas of the edge element. In order to create support surfaces that are not parallel, in particular the height of the edge element may vary at different points.

Further, the invention relates to a view panel for a pair of goggles or a helmet visor, comprising an adapter means according to the invention, at least one outer panel arranged on the first support surface and at least one inner panel arranged on the second support surface.

In a view panel according to the invention, the outer panel and the inner panel are arranged in particular directly on the adapter means. The connection may be established by gluing, welding, a magnetic connection or other connecting techniques.

Preferably, the connection is established in such a manner that no condensate water can form in the interior of the view panel, i.e. between the inner and outer panel. Thus, the connection between the panels and the adapter means is preferably established in a fluid-tight or vapour-tight manner.

Optionally, it may be provided that at least one optical lens, i.e. a visual aid for correcting defective vision, is integrated in the inner panel. Preferably, the optical lens is positioned on the inner panel. Preferably, two optical lenses are provided, for example, for being able to compensate for different dioptre values of the user.

Optionally, it may be provided that the inner panel has or is a frame element, which frames the optical lens. The optical lens may be connected to the frame element. The frame element may be connected to the adapter means. Thus, it may be provided that the adapter means and the optical lens are not directly connected.

Preferably, the frame element has the same curvature profile as the optical lens on the side facing the adapter means.

Optionally, it may be provided that the curvature profile of the outer panel is parallel to the curvature profile of the first support surface. It may also be provided that the curvature profile of the inner panel is parallel to the curvature profile of the second support surface. Thus, the panels may abut the adapter means in a flush manner, which allows a stable connection.

Optionally, it may be provided that the curvature profile of the side of the optical lens facing the adapter means is parallel to the curvature profile of the second support surface.

In particular, it may be provided that the curvature profile of the side of the optical lens facing the adapter means is parallel to the curvature profile of the inner panel. This prevents imaging errors and reflections, which improves wearing comfort.

Further, the present invention relates to a pair of goggles, preferably sports goggles, ski goggles, motorcycle goggles or safety goggles, or a helmet visor, in particular a visor for fire brigade helmets or police or military protective helmets, comprising a view panel according to the invention.

Goggles in the sense of the present invention may refer to any means suitable for protecting the eyes of a user. Goggles in the sense of the present invention also comprise welding masks and any other safety goggles.

Further, the present invention relates to a helmet with a helmet visor according to the invention.

Further features of the invention become apparent from the patent claims, the figures and the description of the exemplary embodiment.

In the following, the present invention is explained in detail on the basis of a non-limiting exemplary embodiment.

In the figures:

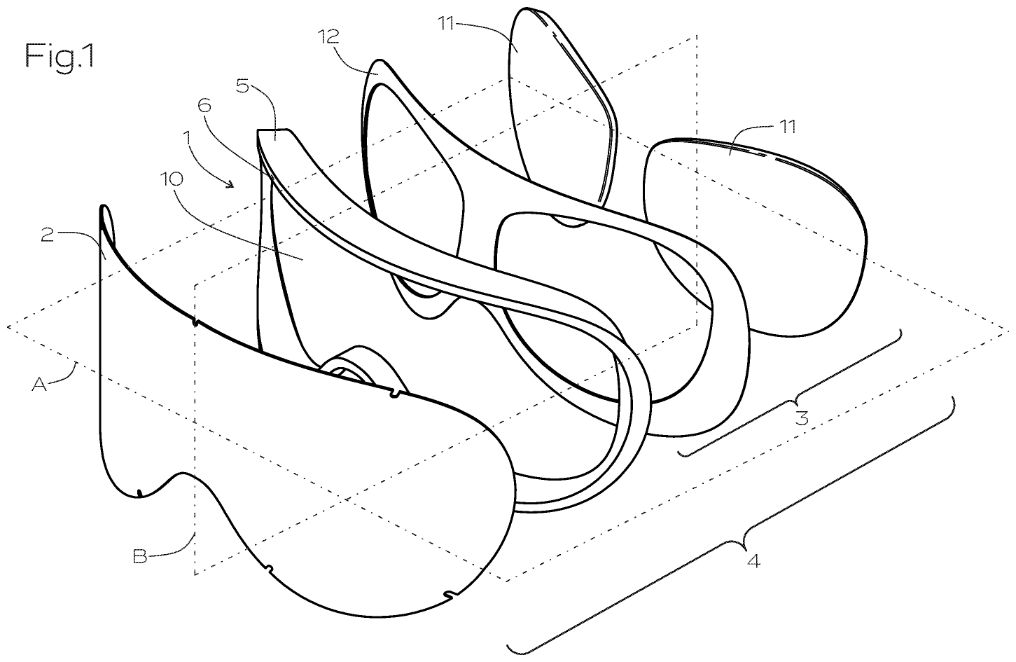

FIG. 1 shows an exploded view of a first exemplary embodiment of a view panel according to the invention;

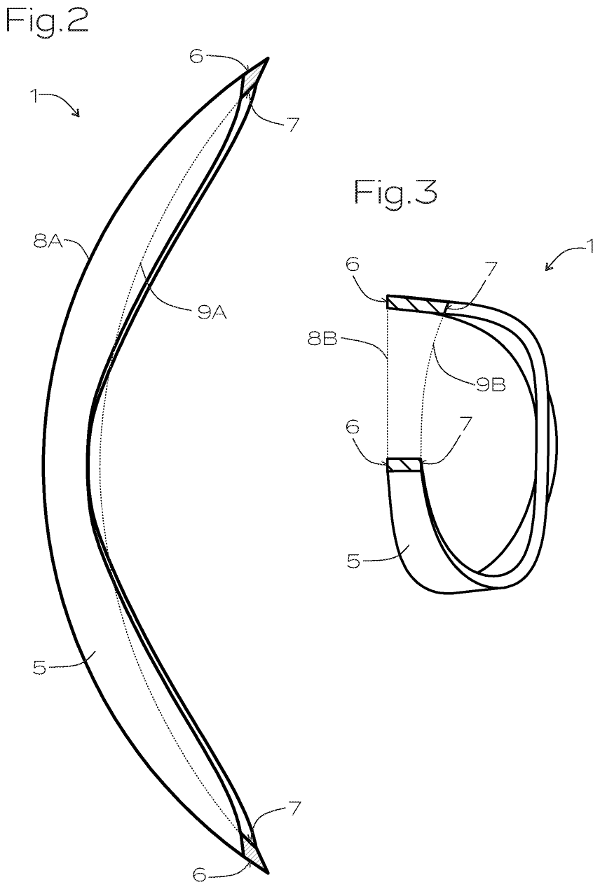

FIG. 2 shows a sectional view of the adapter means of FIG. 1; and

FIG. 3 shows a further sectional view of the adapter means of FIG. 1.

FIG. 1 shows an exploded view of a first exemplary embodiment of a view panel 4 according to the invention for use in a pair of motocross goggles.

The view panel 4 comprises an outer panel 2, an adapter means 1 and an inner panel 3. The inner panel 3 consists of a frame element 12, which frames two optical lenses 11.

The adapter means 1 comprises a bar-shaped circumferential edge element 5, which surrounds one single viewing clearance 10.

In this exemplary embodiment, the outer panel 2 and the inner panel 3 are glued to the adapter means 1 to ensure a stable connection.

The curvature profile of the outer panel 2 corresponds to the curvature profile of the first support surface 6, while the curvature profile of the inner panel 3 corresponds to the curvature profile of the second support surface 7. The geometries of the curvature profiles are explained in detail below by reference to FIGS. 2 and 3.

In this exemplary embodiment, the outer panel 2 is a toric panel for a pair of motocross goggles. The inner panel 3 is a spherical panel with the two optical lenses 11, which are integrated into the frame element 12. The curvature profile of the frame element 12 corresponds to the curvature profile of the optical lenses 11 on the side facing the adapter means 1.

The geometries of the curvature profiles are explained in detail below by reference to FIGS. 2 and 3.

FIG. 2 shows a sectional view of the adapter means 1 along the first sectional plane A shown in FIG. 1. FIG. 3 shows a further sectional view of the adapter means 1 along the second sectional plane B shown in FIG. 1.

The sectional planes A, B are mutually orthogonal and, thus, the sectional views shown in FIGS. 2 and 3 show mutually orthogonal curvature curves 8A, 8B, 9A, 9B of the support surfaces 6, 7. The sectional plane A is horizontal; the sectional plane B vertical.

In FIG. 2, in which a sectional view of the adapter means 1 with the first support surface 6 and the second support surface 7 is shown, the first curvature curve of the first support surface 8A and the first curvature curve of the second support surface 9A are shown. In this view, the first curvature curve of the first support surface 8A coincides with the first support surface 6 and is thus, unlike the first curvature curve of the second support surface 9A, not indicated by a dashed line.

It can be seen that both of the curvature curves 8A, 9A shown in FIG. 2 have an arcuate shape, but a different radius of curvature.

In FIG. 3, in which a further sectional view of the adapter means 1 with the first support surface 6 and the second support surface 7 is shown, the second curvature curve of the first support surface 8B and the second curvature curve of the second support surface 9B are shown.

The second curvature curve of the first support surface 8B forms a straight line. Thus, the curvature curves of the first support surface 8A, 8B differ and the first support surface has a toric geometry.

The second curvature curve of the second support surface 9B has an arcuate shape. The radius of curvature of the second curvature curve of the second support surface 9B corresponds to the radius of curvature of the first curvature curve of the second support surface 9A. Thus, the second support surface 7 has a spherical geometry in this exemplary embodiment.

The view panel 4 of the first exemplary embodiment may be integrated into a pair of motocross goggles in a known manner. Other exemplary embodiments, which are not shown, relate to view panels 4 for use in other goggles or safety visors.

### LIST OF REFERENCE SIGNS

1 adapter means
2 outer panel
3 inner panel
4 view panel
5 edge element
6 first support surface
7 second support surface
8A, 8B curvature curve of the first support surface
9A, 9B curvature curve of the second support surface
10 viewing clearance
11 optical lens
12 frame element
A first sectional plane
B second sectional plane

1. A view panel for a pair of goggles or a helmet visor, comprising an adapter means (1), at least one outer panel (2) arranged on a first support surface (6) of the adapter means (1) and at least one inner panel (3) arranged on a second support surface (7) of the adapter means (1), wherein the adapter means (1) comprises at least one bar-shaped edge element (5) with the first support surface (6) and the second support surface (7), wherein the support surfaces (6, 7) are not parallel to one another, characterized in that at least one optical lens (11) is integrated in the inner panel (3) and in that the inner panel (3) comprises or is a frame element (12), which frames the optical lens (11).

2. The view panel according to claim 1, characterized in that
a. the first support surface (6) has a first curvature profile, which is formed by two curvature curves (8A, 8B), and
b. the second support surface (7) has a second curvature profile, which is formed by two curvature curves (9A, 9B),
c. wherein the first curvature profile differs from the second curvature profile.

3. The view panel according to claim 2, characterized in that the first curvature profile has no curvature, a curvature in only one spatial direction, or a curvature in two mutually orthogonal spatial directions.

4. The view panel according to claim 2, characterized in that the second curvature profile has no curvature, a curvature in only one spatial direction, or a curvature in two mutually orthogonal spatial directions.

5. The view panel according to claim 2, characterized in that at least one curvature curve (8A, 8B, 9A, 9B), preferably both curvature curves, of the first support surface (6) or the second support surface (7) have a substantially arcuate shape.

6. The view panel according to claim 2, characterized
in that the first curvature profile is formed by two curvature curves (8A, 8B) whose radii of curvature are substantially different, and
in that the second curvature profile is formed by two curvature curves (9A, 9B) whose radii of curvature are substantially the same.

7. The view panel according to claim 1, characterized in that a viewing clearance (10) is provided in the edge element (5).

8. The view panel according to claim 1, characterized in that the edge element (5) is designed as a single piece.

9. The view panel according to claim 1, characterized in that multiple, preferably two, edge elements (5) are provided.

10. The view panel according to claim 1, characterized in that the outer panel (2) and/or the inner panel (3) is/are glued, welded or magnetically connected to the adapter means (1).

11. The view panel according to claim 1, characterized in that the curvature profile of the outer panel (2) is parallel to the curvature profile of the first support surface (6), and in that the curvature profile of the inner panel (3) is parallel to the curvature profile of the second support surface (7).

12. The view panel according to claim 1, characterized in that the curvature profile of the side of the optical lens (11) facing the adapter means (1) is parallel to the curvature profile of the second support surface 7), in particular parallel to the curvature profile of the inner panel (3).

13. A pair of goggles, preferably a pair of sports goggles, ski goggles, motorcycle goggles or safety goggles, or a helmet visor, in particular a visor for fire brigade helmets or police or military protective helmets, comprising a view panel according to claim 1.

14. A helmet having a helmet visor according to claim 13.

15. (canceled)

16. (canceled)

17. (canceled)
